(19) United States
(12) Patent Application Publication
(10) Pub. No.: US 2005/0053275 A1
(43) Pub. Date: Mar. 10, 2005

(54) Method and system for the modelling of 3D objects

(76) Inventor: David Stokes, West Midlands (GB)

Correspondence Address: Michael J. Gratz;BOYLE, FREDRICKSON, NEWHOLM, STEIN & GRATZ, S.C., Suite 1030, 250 East Wisconsin Avenue, Milwaukee, WI, 53202, US

(21) Appl. No.: 10/887,134

(22) Filed: Jul. 8, 2004

(30) Foreign Application Priority Data
Jul. 8, 2003 (GB) GB 0315916.7

(51) Int. Cl. G06K 9/00

(52) U.S. Cl. 382/154

(57) ABSTRACT

A system arranged to model a 3D object comprising an image acquiring means arranged to receive a single 2D image of a subject and processing circuitry 104. The system is arranged to acquire an image 300 from the image acquiring means 110, process the image using the processing circuitry 102 and generate a 3D computer model 2300 of the object from the image. The image acquiring means may for example a digital camera; a scan of an image; a digital video recorder; a DVD player; a network connection or a machine readable medium. The system may comprise generating a physical model from the computer model 2300.

### FIELD OF THE INVENTION

This invention provides a system and method for the modelling of three dimensional (3d) objects.

### BACKGROUND OF THE INVENTION

Various techniques are known for generating 3D models from objects. For example it is known to probe the surface of an object, using various kinds of probing system, to generate a 3D model of that object. This 3D model can then be used to drive a Computer Numerically Controlled (CNC) machine tool to fabricate a facsimile of the object. Known scanning systems include laser scanning systems, 3D digitising systems and the like. Known digitising systems include those such as the Minolta™ VIVID 900™ the output of which can be directly used to generate tool paths for CNC machines. However, such probing systems are generally expensive, possibly costing tens of thousands of pound, and are therefore, not necessarily suitable for every application.

Further, it is known to generate grey-scale images by scanning photographs and then use that grey-scale image to generate a lithophane. Such a process is described in patent applications such as EP 1 119 448.

It has generally been thought that the scanning of photographs is not suitable for generating 3D models since it does not directly contain depth information. It is purely the viewer's brain that interprets the contents of a photograph and introduces depth awareness. That is the brain becomes accustomed to everyday objects, such as faces, and is capable of interpreting the information contained in photographs to provide 3D information in view of its prior knowledge as to how that object actually looks.

According to a first aspect of the invention there is provided a system arranged to model a 3D object comprising an image acquiring means arranged to receive an image of a subject and processing circuitry, the system being arranged to acquire an image from the image acquiring means, process the image using the processing circuitry and generate a 3D computer model of the object from the image.

Such a system is advantageous because it helps to automate the process of generating 3D models. The generation of a 3D computer model has generally been time consuming and/or expensive and it had been believed that an image would not be suitable for the generation of a 3D model. The system may be advantageous because it may reduce the complexity of the hardware required to produce a 3D computer model; it removes the need for probes, and the like.

Conveniently, the image acquiring means may comprise any means of acquiring a digital image and may for instance comprise any of the following: a digital camera; a scan of an image; a digital video recorder; a DVD player; a network connection; a machine readable medium; or the like.

The 3D computer model may comprise a low relief representation of the object. Such low reliefs are often known as bas-reliefs. Such low reliefs have previously been hand crafted and have taken many hours to achieve. Therefore, providing an automated process that allows the fabrication of a low relief is particularly advantageous because it reduces the time required to generate the low relief. Further, because low reliefs have been hand crafted the fabrication thereof is open to artistic interpretation on the part of the sculpture and the relief may not be a true representation of the object. A further advantage of providing a system to generate the relief is that it may allow more accurate representations to be fabricated. For the avoidance of doubt low reliefs include any of the following: the representation of a head on a coin, the representations of heads on crockery, seal rings, jewellery, cameos, intaglios, a relief for the memorial industry (for providing reliefs on headstones and the like), etc.

Low, or bas, reliefs are advantageous for some arts in which it is desirable to provide a realistic impression of the original article, rather than a true representation of the original. If a 3D model of an object, for example a head, is scaled down so that it can be represented on a coin or the like, then features within the object, such as ears, are often lost. Thus, in a bas-relief the relative dimensions of the various features within the original are altered relative to one another.

The system may comprise a head acquiring means arranged to isolate heads, preferably human, within an image acquired by the image acquiring mean. Such a head acquiring means is convenient because there is a large market for the generation of physical models of heads, particularly of low relief physical models of human heads.

The processing circuitry may comprise a surface generation means arranged to generate a surface from the image. The surface generation means may be arranged to process the image and allocate depth information to each pixel of the image according to the value (generally the grey-scale value) of that pixel. Conveniently, black (generally having a minimum value) is taken to have the lowest height, and white (generally having a maximum value) is taken to have the highest height. It will be appreciated that grey-scales are typically 8 bit and therefore have 256 different shades of grey associated therewith. Of course, other grey-scale depths are possible and may have roughly any of the following number of bits (or any number in between): 12, 16, 24, 32, 48. The figures used in this paragraph are examples of typical values for black and white should an 8 bit grey scale be used. The skilled person will readily appreciate the values that would exist if grey-scales having a different number of bits be used. Thus, the surface generation means may be thought of adding a further dimension to the bit-map image created by the scan. This image with the further dimension is sometimes referred to as a 2½D image, and each pixel to which depth information has been added is sometimes represented by at least one voxel (a pixel having predetermined dimensions in the x, y and z directions), or as a pixel having a height in the z dimension.

The processing circuitry may also comprise a smoothing means arranged to smooth the surface generated by the surface generation means. Such a smoothing means is advantageous because it allows surface defects, blemishes in the scan, or the like to be removed from the surface which other wise may spoil the computer model produced by the system.

Further, the processing circuitry may comprise a shell generation means arranged to generate a shell from the surface generated by the surface generation means. Such a shell is convenient because it allows the computer model to be produced by a rapid prototyping machine (sometimes referred to as a 3D printer).

Conveniently, the processing circuitry may comprise a polygon generation means arranged to generate a set of planar tessellating polygons representing the surface generated by the surface generation means. In the most preferred embodiment the polygon generation means is arranged to generate a set of planar polygons representing the surface of the shell generated by the shell generation means. Such a set of planar polygons is convenient because it provides a convenient manner to represent the surface. Most conveniently, the polygons are triangles. Sets of planar triangles are well known in the field of computer graphics.

The system may further comprise a rapid prototyping machine arranged to fabricate a physical representation (i.e. a physical model) of the 3D computer model. The use of a rapid prototyping machine is convenient because, as its name suggests, its output is produced rapidly, but is also produced cheaply.

Alternatively, or additionally, the system may further comprise a CNC machine arranged to generate a physical representation (i.e. a physical model) of the 3D computer model.

The system may comprise a vector creation means arranged to generate one or more vectors, which are representations of separate shapes such as lines, polylines, polygons and splines. The skilled person will appreciate the difference between what is termed a vector, in the art, and a discretised representation such as a bitmap. Such a means is advantageous for processing the image to generate the model.

The system may comprise an edge detection means arranged to detect an outline of a portion of the image. Such an edge detection means may prove advantageous for the generation of vectors and may reduce the amount of user inputs required by the system.

The system may comprise a blending means arranged to create a blend surface from a vector onto the model of the surface. Such an arrangement may provide a convenient way of modifying the computer model during creation thereof.

According to a second aspect of the invention there is provided a method of generating a 3D computer model of an object comprising the following steps:
i. acquiring an image;
ii. using the image to obtain depth information relating to the object;
iii. applying the depth information to a template of model and producing a 3D computer model from said depth information and said template.

An advantage of such a method is that it is convenient and allows a computer model to be rapidly produced. Further, means for acquiring images are well known are widely available and are now inexpensive and therefore the expense of producing the computer model is reduced. Therefore, the method allows the model to be generated without the need for expensive probing systems which have generally been required in order to generate computer models from objects.

Conveniently, the method is arranged to generate a physical model from the computer model that has been generated. The physical model is preferably produced using a rapid prototyping machine (3D printer), but may use a CNC milling machine, or the like in order to generate the physical model.

Preferably, the method generates a low relief from the object. Such low reliefs are particularly convenient for certain arts. These arts include the art of producing coins, producing pottery, stone masonry, water marks, jewellery (including intaglio or cameo), card embossing, security, or similar. Generally, the method may prove to be applicable to arts in which a low relief of human head is required.

Once the image has been acquired it may be converted into a relief generally by taking the value one or more of the pixels of the image into a height. Such a step provides a convenient starting point for the creation of the computer model.

In some embodiments, the next step in the method may be to remove discontinuities from the surface. However, some embodiments of the invention may not require this step. It will be appreciated that should an object have a dark spot thereon this dark spot will be interpreted as having a low depth. As such the spot may manifest itself as a hole on the surface and constitute a discontinuity. Therefore, removing any discontinuities is advantageous because it helps to generate a more realistic computer model.

Removal of the discontinuities may comprise copying portions of the image to overlie the discontinuities. Such an arrangement is convenient and provides a simple manner in which to remove the discontinuities.

In some embodiments the method is used to generate a 3D computer model of a head. Should the object being modelled comprise a head then the discontinuities removed by the method may include facial hair (for example beards, moustaches, etc.), moles, scars, birth marks, wrinkles, etc.

The method may comprise using a vector creation means to generate a vector around an outline of at least a portion of the image. The vector around the outline may be thought of as a silhouette vector. The method may comprise providing an edge detection means to detect the outline of at least a portion of the image. Alternatively, or additionally, a user may define the outline of at least a portion of the image.

Conveniently, the method uses the silhouette vector to define a portion of the image from which information may be discarded. For example, it is likely that the silhouette vector defines a closed loop and if this is the case the method may discard information that is outside the loop. Of course, the method may discard information that is inside the loop. Information may be discarded by assigning that area to have a zero height.

The vector creation means may be used to create a height defining vector that is used to roughly set the height of the computer model. The height defining vector may have a tangent that is roughly parallel to a tangent of the silhouette vector.

The height defining vector may be displaced from the silhouette vector by a predetermined amount. Such a method is convenient because it provides a convenient way of automating the creation of the height defining vector.

The method may assign a height to the height defining vector.

Conveniently, the method blends the height defining vector and the silhouette vector, generally with a concave blend.

Further, the method may cause the vector creation means to define a further vector outlining a portion of the image. Should the portion of the image being modelled comprise a head then this vector may be thought of as an upper head region defining vector. Again, in embodiments in which the image being modelled comprises a head then such a method can be useful in order to start correction of height information relating to the hair, which is generally given in correct height information when the image is converted to a relief.

The method may ask a user thereof to specify predetermined points on the image which are used to generate the further vector, which may be the upper head region defining vector. In the case of a method in which the image being modelled is a head then the points may comprise any of the following regions on the head: an eyebrow region; a temple region; a centre of the ear region; a nape of the neck region. Such a method step may prove convenient and allow the method to generate the vector with reduced, and what may be minimal, user inputs.

Alternative, or additional, methods may try and fit the further vector automatically without any user inputs. Such methods may not be practical due to potential difficulties in determining the further vector.

The method may intersect the vector outlining a portion of the image (which may be the upper head region defining vector with the silhouette vector) to generate a further vector. In embodiments in which the image being modelled comprises a head then the resulting vector may comprise an upper head region outline vector.

Conveniently, the method blends the model with the upper head region outline vector, preferably with a concave blend.

At this stage in the method the model may be thought of as a template for the object being modelled onto which information may be added to generate the final computer model.

The method may subtract height information from the image from the template and may subsequently smooth the resulting model.

Further, the method may then add height information from the image to the model.

Further, the resulting model may have smoothing performed thereon, which is preferably localised smoothing. Such an arrangement is advantageous because it can help to remove imperfections in the model that are created by noise within the image.

After the surface has been produced, the method may include the step of generating a shell from the surface. Creating the shell may be likened to giving the surface a thickness, and such a step is advantageous if the method is to be used to generate a physical model corresponding to the computer model.

The method may comprise fitting a plurality of planar tessellating polygons to cover the created surface and/or the created shell. Such an arrangement is advantageous, because it provides a powerful way of representing the surface, whilst aiding the reduction in processing power required to manipulate the computer model. Preferably, the polygons are triangles and preferably the method ensures that the polygons cover the shell and/or surface completely.

Conveniently, the method may comprise generating a physical model from the computer model. The physical model may be generated by a CNC milling machine, a rapid prototyping machine (3D printer), or the like. Commonly known 3D printers include those using sterolithography, selective laser sintering, fused deposition modelling, laminated object modelling, inkjet deposition.

Further, the resulting physical model may be useful for mass production, plastic moulding, pressing, stamping dies, or the like.

The method may ensure that the shell covered with polygons and produced by the method has no discontinuities (i.e. sometimes known as the polygons being fully connected), or areas not covered by a polygon, therein, i.e. is what is termed in the art as “watertight”. Such an arrangement is particularly convenient if a physical model is to be generated, especially, if it is to be generated using a rapid prototyping machine. If there are areas not covered by polygons, these can lead to excess material being added during fabrication of the physical model, or the 3D printer may simply stop and not be able to produce the model.

In other embodiments the method may generate slices through the model. Such slices are convenient for driving some types of machine and are therefore convenient to allow the method to drive a plurality of machines.

The method may comprise providing tools that manipulate the computer model. In some embodiments tools are provided to remove hair from the computer model and/or the grey-scale scan. Such an arrangement is particularly convenient in embodiments in which the scanned object is a human head. The tools may be semi-automatic and require user intervention. For example, the tool may place a vector profile onto the scanned image and/or the computer model and require that the user manipulate the vector profile to match the outline of the hair on the head.

According to a third aspect of the invention there is provided a machine readable medium containing instructions to cause a computer to function as the system of the first aspect of the invention when programmed thereonto.

According to a fourth aspect of the invention there is provided a machine readable medium containing instructions to cause a computer to perform the method of the second aspect of the invention when programmed thereonto.

According to a fifth aspect of the invention there is provided a data structure comprising a bit map image to which height information has been assigned to each pixel of said bit map.

According to a sixth aspect of the invention there is provided a machine readable medium containing a data structure according to the fifth aspect of the invention.

Preferably the data structure allows a computer to generate a 3D computer model.

The machine readable medium of the third, fourth, or sixth, aspects of the invention may comprise any one or more of the following: a floppy disk, a CDROM, a DVD ROM/RAM (including +RW, −RW), a hard drive, a non-volatile memory, any form of magneto optical disk, a wire, a transmitted signal (which may comprise an internet download, an ftp transfer, or the like), or any other form of computer readable medium.

According to a seventh aspect of the invention there is provided an object produced by the method of the second aspect of the invention.

The object may be any one of the following: the representation of a head on a coin, the representations of heads on crockery, seal rings, jewellery, cameos, intaglios, a relief for the memorial industry (for providing reliefs on headstones and the like),

### BRIEF DESCRIPTION OF THE DRAWINGS

There now follows, by way of example only, a description of an embodiment of the present invention with reference to the accompanying drawings, of which:

FIG. 1 schematically shows a computer system such as may be used in performing the method of the invention;

FIG. 2 shows a flowchart outlining the stages of image manipulation used in performing the method of the invention;

FIGS. 3-24 show progressive stages in the manipulation of an image used to produce a three dimensional computer model;

FIG. 25 shows a computer driving a CNC machine to fabricate a physical model from a computer model;

FIG. 26 shows a computer driving a rapid prototyping machine to fabricate a physical model from a computer model; and

FIG. 27 shows details of a memory of the computer system of FIG. 1.

### DETAILED DESCRIPTION OF THE DRAWINGS

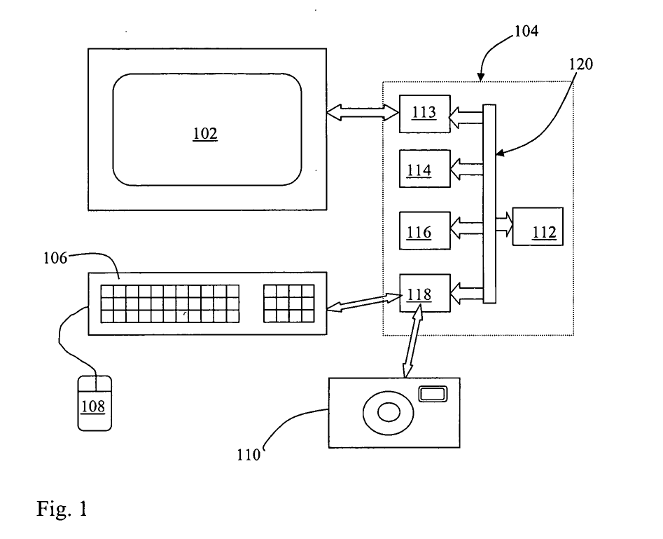

The computer system of FIG. 1 comprises a display 102, processing circuitry 104, a keyboard 106, a mouse 108 and an image acquiring means (in this case a digital camera) 110. The processing circuitry 106 comprises a processing unit 112, a graphics system 113, a hard drive 114, a memory 116, an I/O subsystem 118 and a system bus 120. The processing unit 112, graphics system 113 hard drive 114, memory 116 and I/O subsystem 118 communicate with each other via the system bus 120, which in this embodiment is a PCI bus, in a manner well known in the art.

The graphics system 113 comprises a dedicated graphics processor arranged to perform some of the processing of the data that it is desired to display on the display 102. Such graphics systems 113 are well known and increase the performance of the computer system by removing some of the processing required to generate a display from the processing unit 112.

It will be appreciated that although reference is made to a memory 116 it is possible that the memory could be provided by a variety of devices. For example, the memory may be provided by a cache memory, a RAM memory, a local mass storage device such as the hard disk 114, any of these connected to the processing circuitry 104 over a network connection. However, the processing unit 112 can access the memory via the system bus 120 to access program code to instruct it what steps to perform and also to access the data samples. The processing unit 112 then processes the data samples as outlined by the program code.

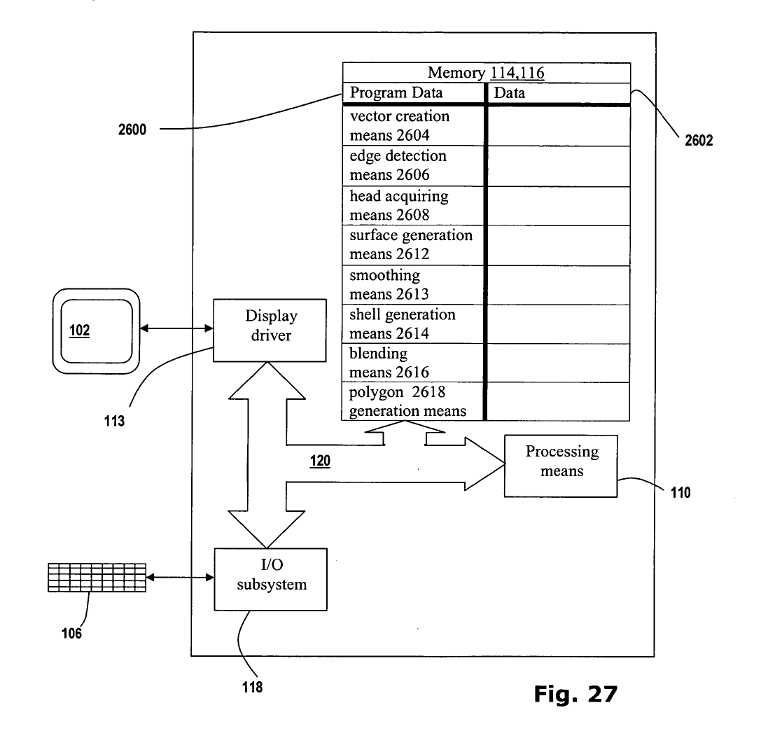

A schematic diagram of the memory 114,116 of the computer system is shown in FIG. 27. It can be seen that the memory comprises a portion 2600 dedicated to program storage and a portion 2602 dedicated to holding data.

Images of different quality can be made including in millions of colours and thousands of dots per inch. As the quality of the image is reduced the amount of data needed to detail the quality is reduced. The lowest level of information required is black and white, which requires 1 bit be pixel to specify the colour information. The next level is 256 level grey-scale, which requires 8 bits (or 1 byte) per pixel to contain the colour information. The embodiment described herein utilises images in 256 level grey-scale at a modest resolution of 600 dots per inch (dpi). Such a colour level and resolution results in images that contain a relatively high level of detail, but a modest level of colour information (8-bits). It will be appreciated that it is possible and a well known process to convert images that are not in this format to the format or indeed many other formats.

The computer system of FIG. 1 is provided with software to enable a user of the system to perform complex image manipulation. The software further enables the greyscale within the greyscale image to be translated as depth information. In one particular embodiment the software is provided by the applicant in its ArtCAM™ software.

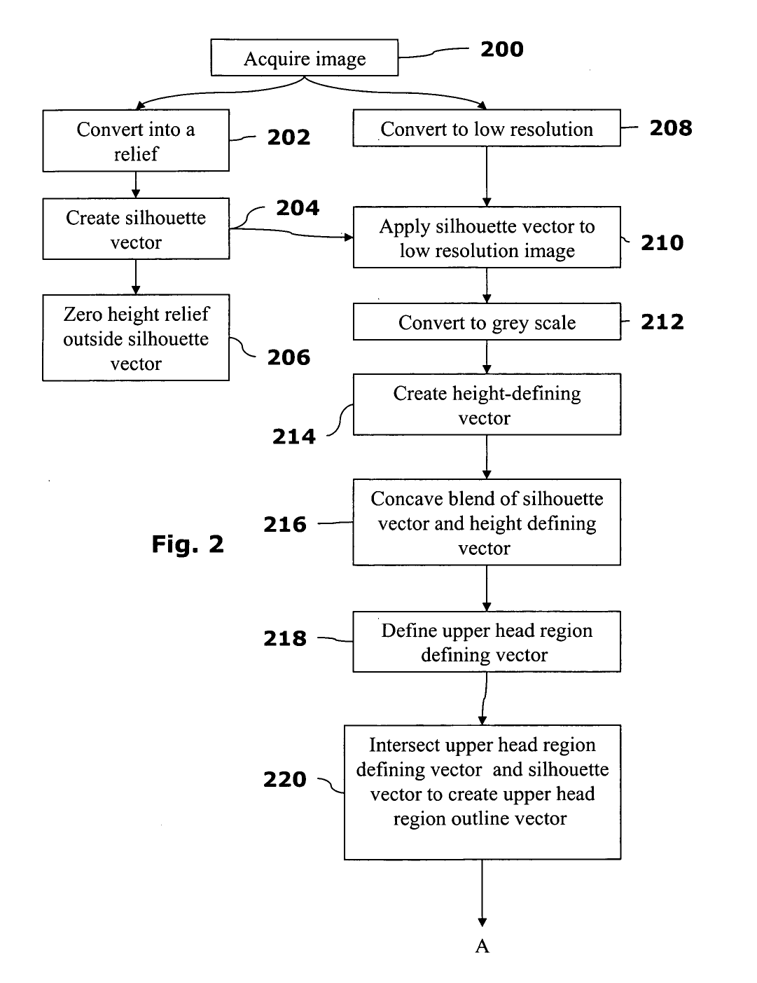

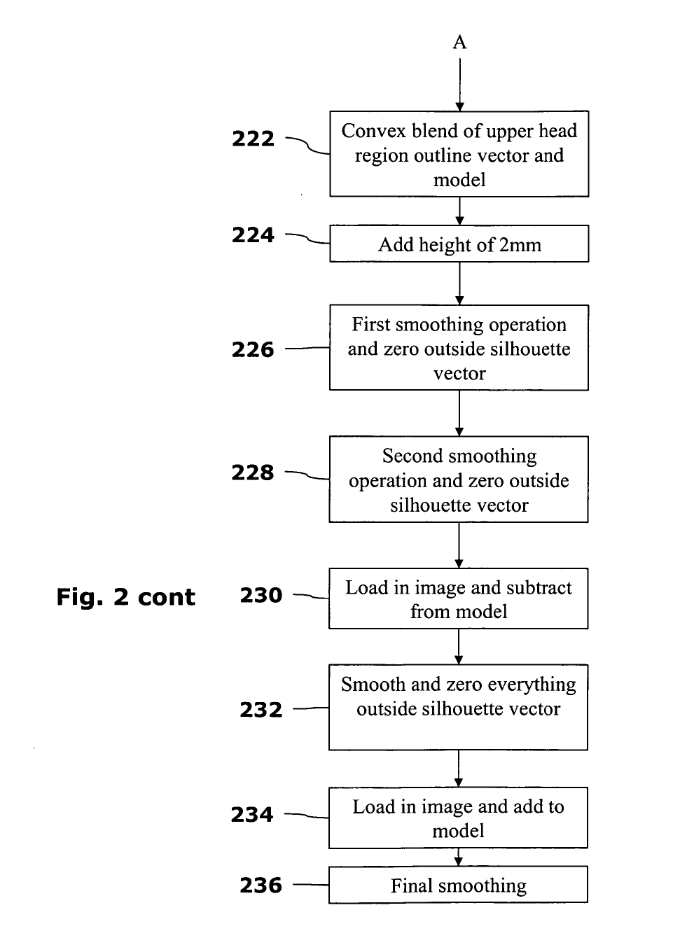

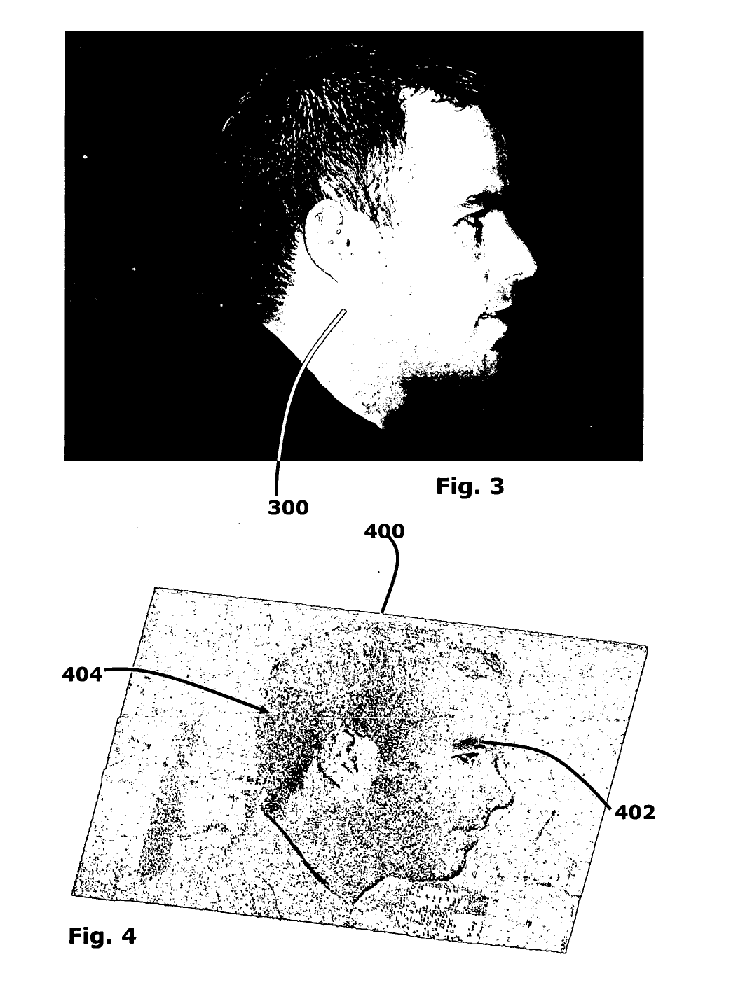

In use, the digital camera 110 is used to acquire (step 200 in FIG. 2) an image which is then transferred using the USB cable to the hard drive 114. An example of such an image is shown in FIG. 3. As discussed the image is either captured as grey scale, or converted to grey scale by the processing unit 112 and comprises a side profile of a head 300.

This image file has a relatively high resolution of, in this embodiment, 2272 pixels×1704 pixels i.e. roughly 3.8 million pixels The skilled person will appreciate that this resolution is given merely be way of example and other resolutions are equally possible.

This image is transformed into a relief 400 by the processing unit 112 (step 202 in FIG. 2). The relief may be thought of as a surface rather than an image and as such a surface generation means 2612 may be used to generate this surface/relief. An example of the relief 400 is shown in FIG. 4. To obtain this relief the grey scale value of each pixel of the grey scale image is converted into height information. However, as the skilled person will appreciate, in a grey-scale black is assigned a minimum value (generally zero) and white is assigned a maximum value (generally 256 if using an 8 bit colour depth). Therefore, the height information in the relief is inaccurate and dark areas such as the hair 404 and eyebrows 402 on the head 300 have the lowest height.

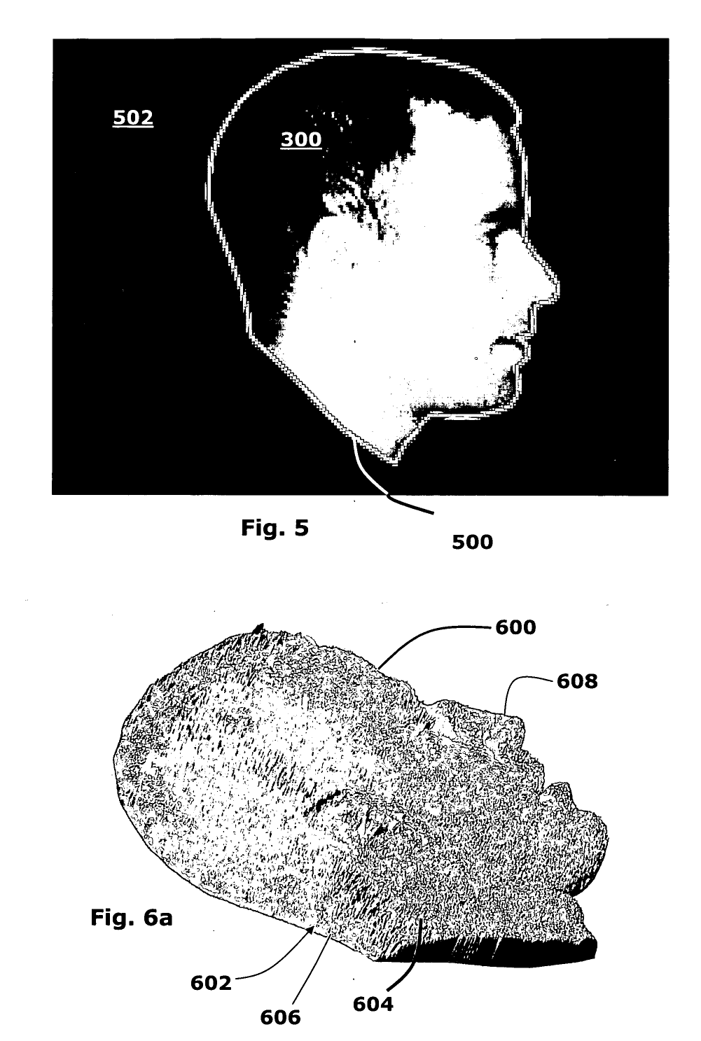

Therefore, the processing steps outlined below are performed in order to correct the height information. As shown in FIG. 5 the first stage in the processes is to create (using a vector creation means 2604) a silhouette vector 500 around the head 300 (step 204 in FIG. 2). This vector may be drawn by an automatic or semi-automatic tool that identifies the edge region of the head 300 from a background 502 of the image. In an alternative, or additional, embodiment the vector 500 may be hand drawn by a user. In either or both embodiments points within the vector 500 may be edited in order to make the vector 500 more closely follow the edge region of the head 300. The term vector is used in this context as a representations of separate shapes such as lines, polylines, polygons and splines. The skilled person will appreciate the difference between what is termed a vector, in the art, and a discretised representation such as a bitmap.

In some embodiments an edge detection means 2606 may be provided in order to allow the vector creation means 2604 to create the silhouette vector 500 automatically, or at least semi-automatically.

The generation of the silhouette vector 500 may utilise a head acquiring means 2608 to determine the location of the head within the image. The head acquiring means may be an alternative, or in addition to the edge detection means 2606.

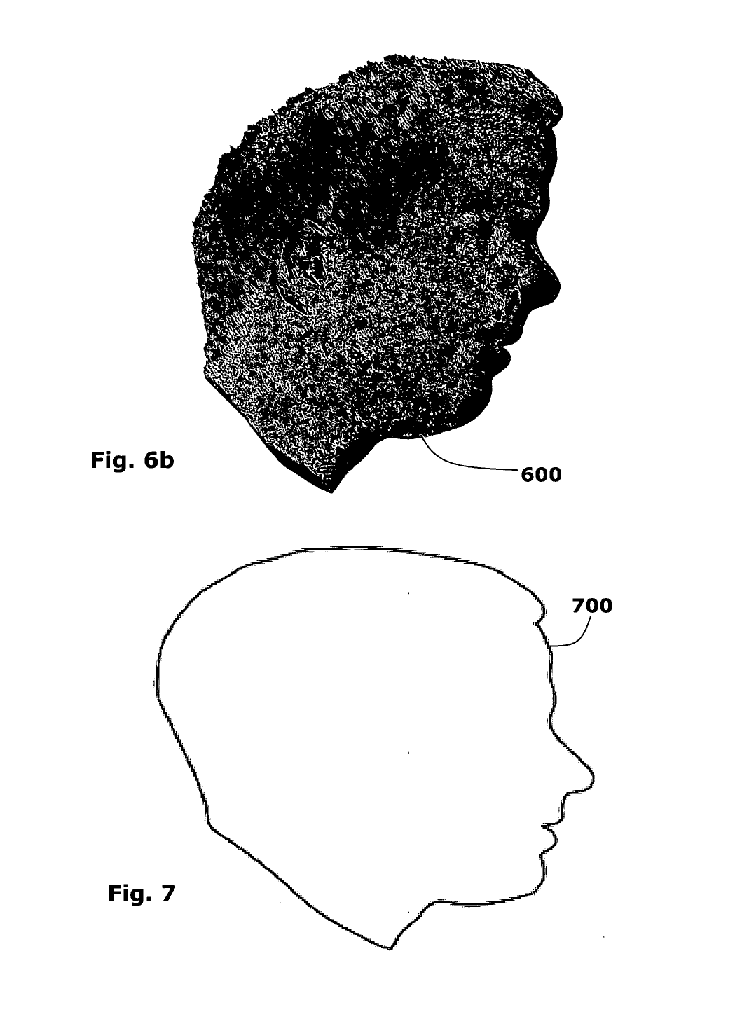

The silhouette vector 500 is then applied to the relief 400 and portions outside of the silhouette vector 500 are assigned a zero height (step 206 in FIG. 2). The resulting relief 600 can be seen in both FIGS. 6a and 6b. The difference between the Figures is that FIG. 6a has been rotated when compared to FIG. 6b to highlight the problems with the height of parts of the relief. The region 602 in which the neck 604 merges with the hair 606 can be seen as one problem area in which the neck 604 steps downwards towards the hair 606. A further problem area is the nose 608, which because of light colour in the original image, is higher than the rest of the relief. These problems are not so visible in FIG. 6b but FIG. 6b more closely resembles the view of the head 300 in the original image and may provide a convenient comparison.

Next a new, second, image file is created and is set to have a relatively low resolution since the purposes that this relief is to be used for will not require very detailed information (step 208 in FIG. 2). It is therefore desirable to reduce the size of the resulting image file (thereby reducing storage requirements and increasing processing time). For example, the relief 400 may contain roughly 600 000 pixels within a 764 pixel square image. The skilled person will appreciate that this resolution is given merely be way of example and other resolutions are equally possible. The second image is also converted to a grey scale.

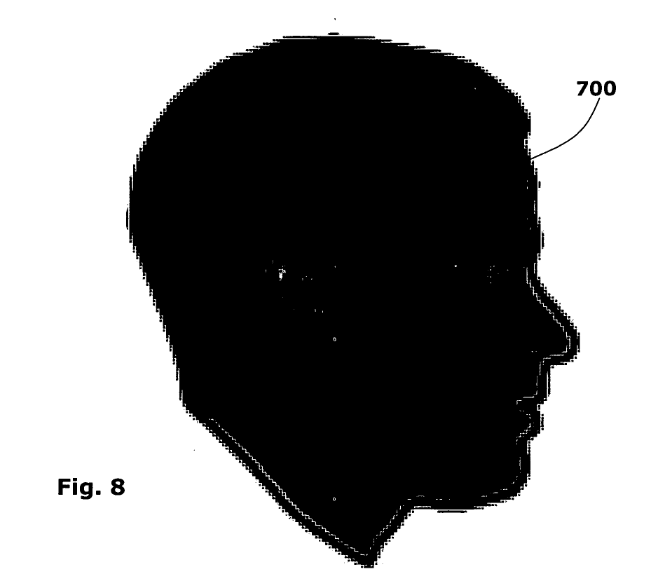

The silhouette vector 500 that was created from the first image file is pasted, scaled and centred with this new second image file (step 210 in FIG. 2) and the new image size is 764×764 pixels. Because the first and second image files are of different sizes it is necessary to set the page centres to one another. FIG. 7 shows an example of the silhouette vector 700 that is automatically applied to the second file and FIG. 8 shows an example of the silhouette vector 700 applied to the second, grey scale low resolution image file (step 212 in FIG. 2).

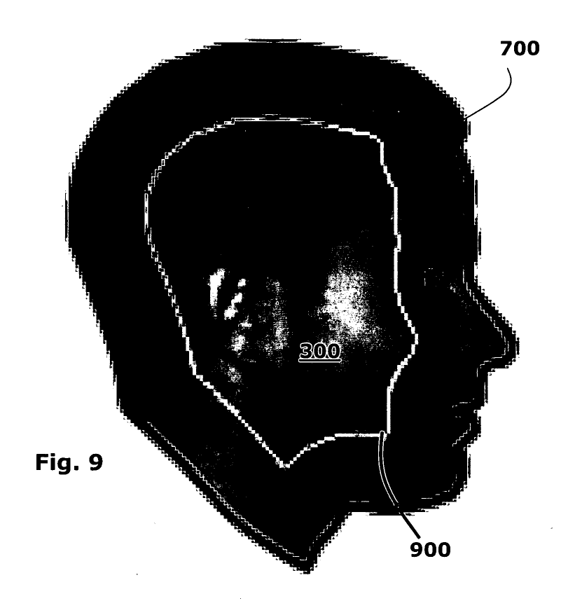

Next, a height-defining vector 900 is created, using the vector creation means 2604, as can be seen in FIG. 9 (step 214 in FIG. 2). This height-defining vector 900 generally has a tangent that is roughly parallel to a tangent of the silhouette vector 500 but is displaced toward the centre of the head 300. In the example given the height-defining vector 900 is displaced by roughly 6 mm from the silhouette vector 500. However, as will be appreciated from the following, the position of the height defining vector affects the position of contours on the final 3D model. It has been found that 6 mm is generally a convenient displacement. Of course, other displacements are possible and roughly any of the following or distances in between may be suitable: 1 mm, 2 mm, 3 mm, 4 mm, 5 mm, 7 mm, 8 mm, 9 mm, 10 mm or 15 mm. For the sake of convenience FIG. 9a shows the silhouette vector 500 and the height-defining vector 900 with the image removed.

The next stage in the method is to blend, using a blending means 2616, the height-defining vector 900 and the silhouette vector 500. To achieve this the height-defining vector 900 is set to be 3 mm above the height of the silhouette vector and a concave blend is specified (step 216 in FIG. 2). Of course, heights are possible and roughly any of the following or distances in between may be suitable: 1 mm, 2 mm, 4 mm, 5 mm, 6 mm, 7 mm, 8 mm, 9 mm or 10 mm.

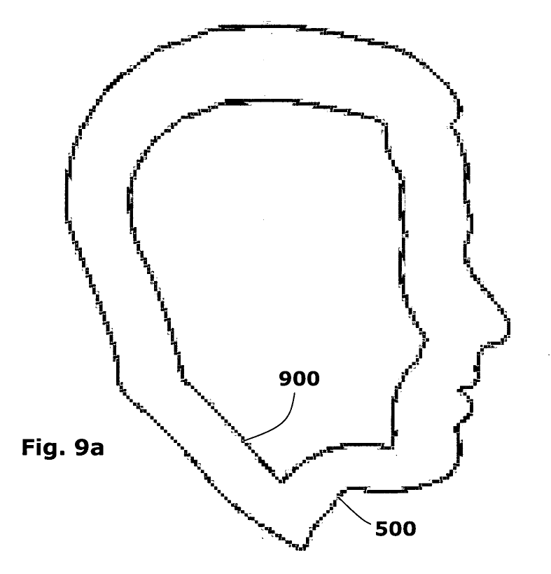

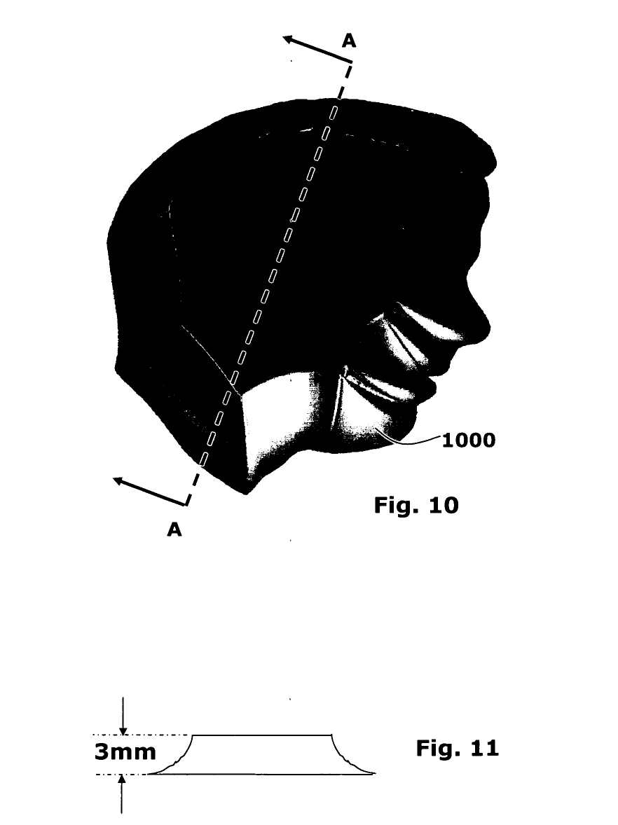

FIG. 10 shows the resulting model 1000 of this blending and FIG. 11 shows an approximation of the cross section that would be achieved by sectioning the model along the line AA. It can be seen that the model being created may be thought of as providing the beginnings of a template for the head which is based around the silhouette vector 500. Further steps of the method are now applied to refine this model before the final low relief model is generated from the image.

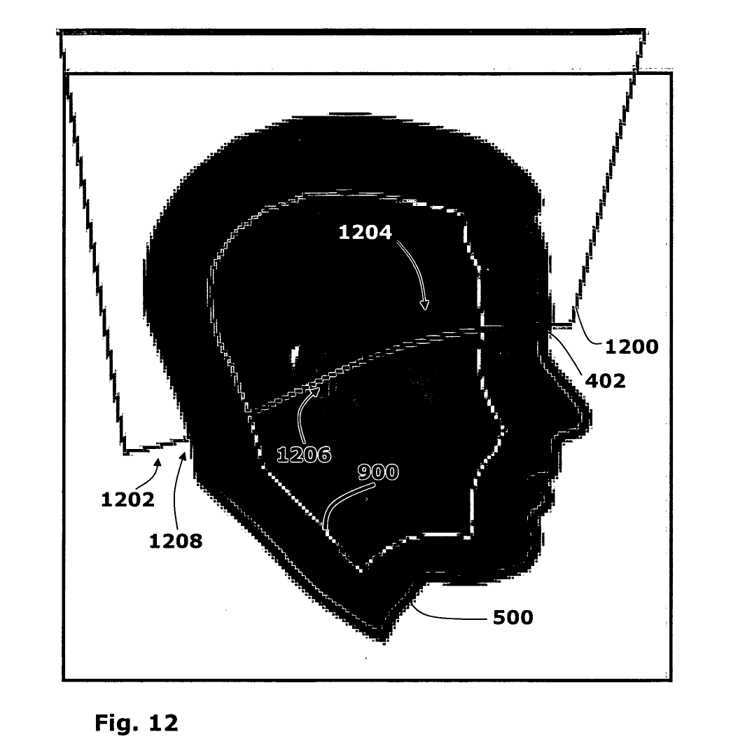

As can be seen from FIG. 12 a third, upper head region defining vector 1200 is created using the vector creation means 2604 (step 218 in FIG. 2). This vector comprises a section 1202 that runs from the eyebrow 402, through a region of the temple 1204, through a centre region of the ear 1206 to the nape of the neck 1208.

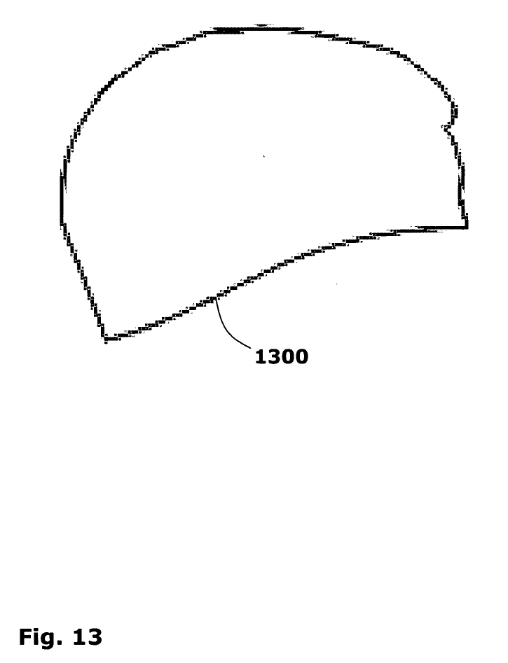

Once this upper head region defining vector 1200 has been created it is intersected with the silhouette vector 500 to create using the vector creation means 2604 the vector 1300 shown in FIG. 13 (step 220 in FIG. 2). As can be seen from the Figure the resulting vector outlines the upper region of the head and may be thought of as an upper head region outline vector 1300.

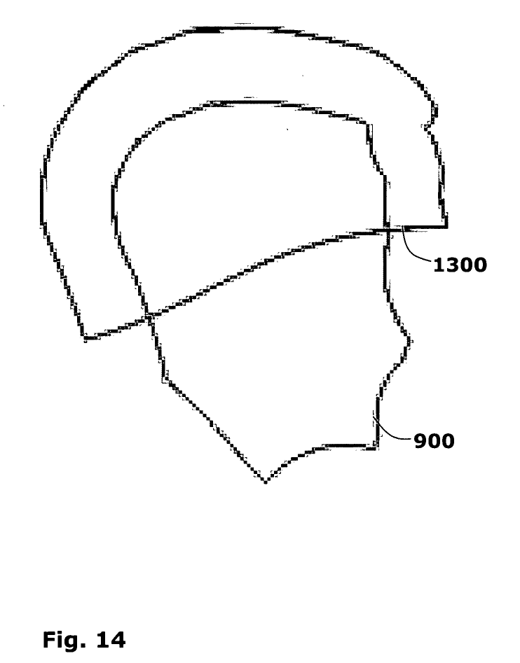

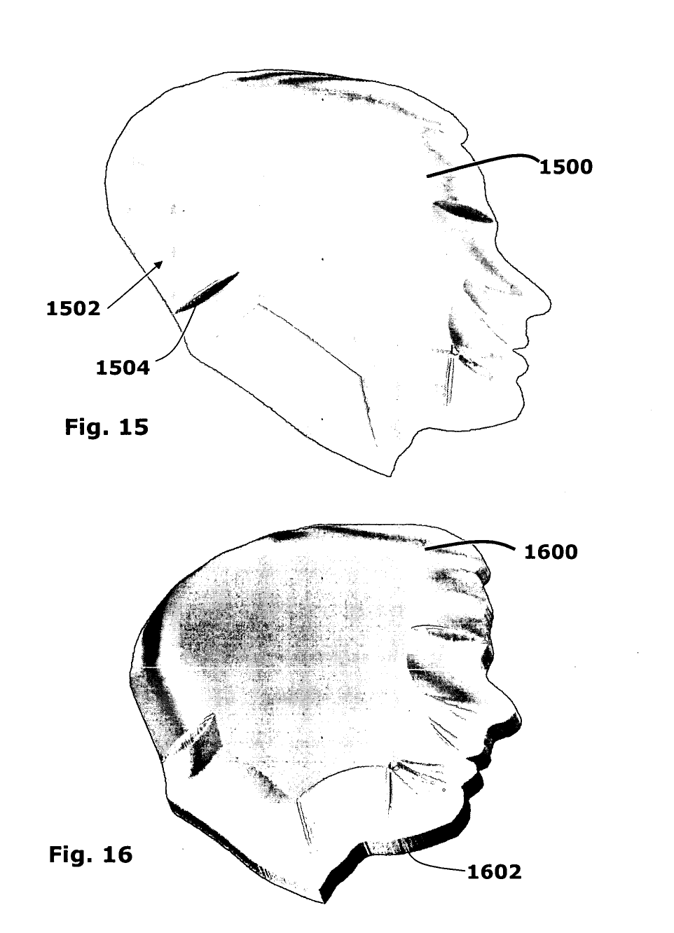

FIG. 14 shows the upper head region outline vector 1300 in comparison with the height-defining vector 900. The next stage of the process is to blend, using the blending means 2616 to perform a convex blend, the upper head region outline vector 1300 of FIG. 13 with the model 1000 of FIG. 10 (step 222 in FIG. 2). The model 1000 and the vector 1300 are both taken to be the same height and the resulting model 1500 is shown in FIG. 15. It can be seen that the region 1502 of the model 1500 falling within the upper head region outline vector 1300 no longer has the concave edge region because a convex blend was used in this stage. Further, steps 1504 occur in the edge region at points corresponding to the upper head region outline vector (not shown in this Figure).

To facilitate future processing a height of 2 mm is added to the model and the resulting model 1600 can be seen in FIG. 16 (step 224 in FIG. 2). Of course, other displacements are possible and roughly any of the following or distances in between may be suitable: 1 mm, 3 mm, 4 mm, 5 mm, 6 mm, 7 mm, 8 mm, 9 mm, 10 mm or 15 mm. A step 1602 around an edge region of the model 1600 that is the result of this addition can be seen in the Figure.

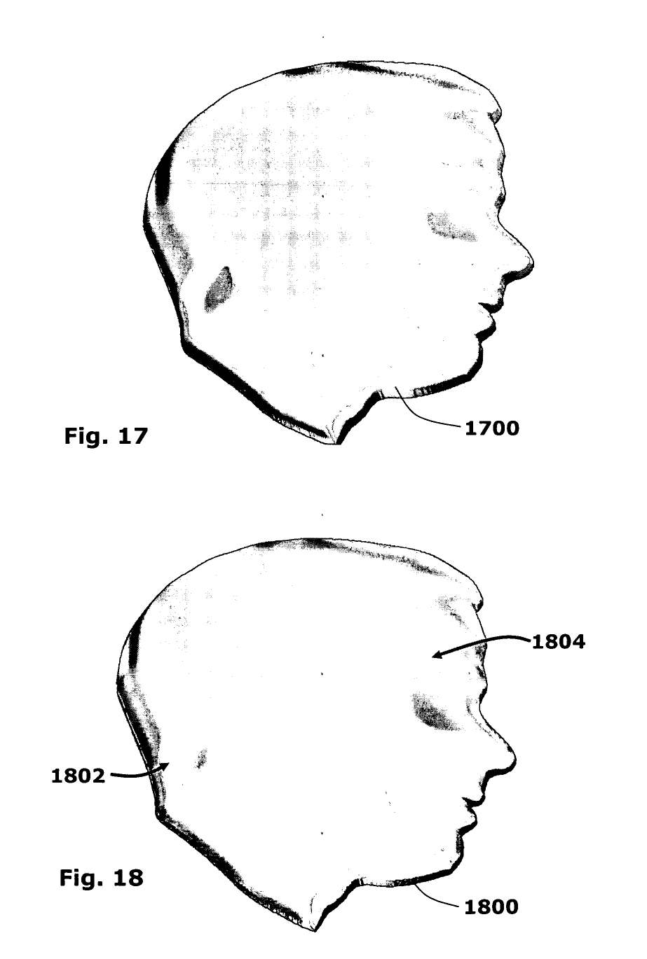

Once the step 1602 has been added to the model, then the model is smoothed using a smoothing means 2613 (step 226 in FIG. 2) to remove discontinuities therefrom. In the embodiment that is being given 100 smoothing passes are made. However, the skilled person will appreciate that any other number of smoothing passes may be made. For example roughly any of the following number (or any number in between these) may be suitable: 10, 20, 30, 40, 50, 60, 70, 80, 90, 110, 120, 130, 140, 150, 160, 170, 180, 190, 200. After the smoothing operation the area outside the silhouette vector 500 is assigned a zero height. The model 1700 that is the result of this process is shown in FIG. 17.

Once the first smoothing step has been performed a second smoothing process is performed using the smoothing means 2613 (step 228 in FIG. 2). Again, 100 smoothing passes are made and again the skilled person will appreciate that any other number of smoothing passes may be made. For example roughly any of the following number (or any number in between these) may be suitable: 10, 20, 30, 40, 50, 60, 70, 80, 90, 110, 120, 130, 140, 150, 160, 170, 180, 190, 200. The model 1800 that results of this second smoothing operation is shown in FIG. 18. Again after the second smoothing process the area outside the silhouette vector 500 is assigned a zero height.

When comparing the model 1700 generated by the first smoothing process and the model 1800 generated by the second smoothing process it will be noted that regions such as the nape of the neck 1802 and eye socket 1804 have been further smoothed. The skilled person will appreciate that the resulting model after having two smoothing operations, each with 100 passes, is different to a single smoothing operation having 200 passes. This is due to assigning the zero height to the area outside the silhouette vector 500 after the first smoothing operation.

The model 1800 shown in FIG. 18 may be thought of as a template of a model to which depth information is applied and which is obtained from the original image.

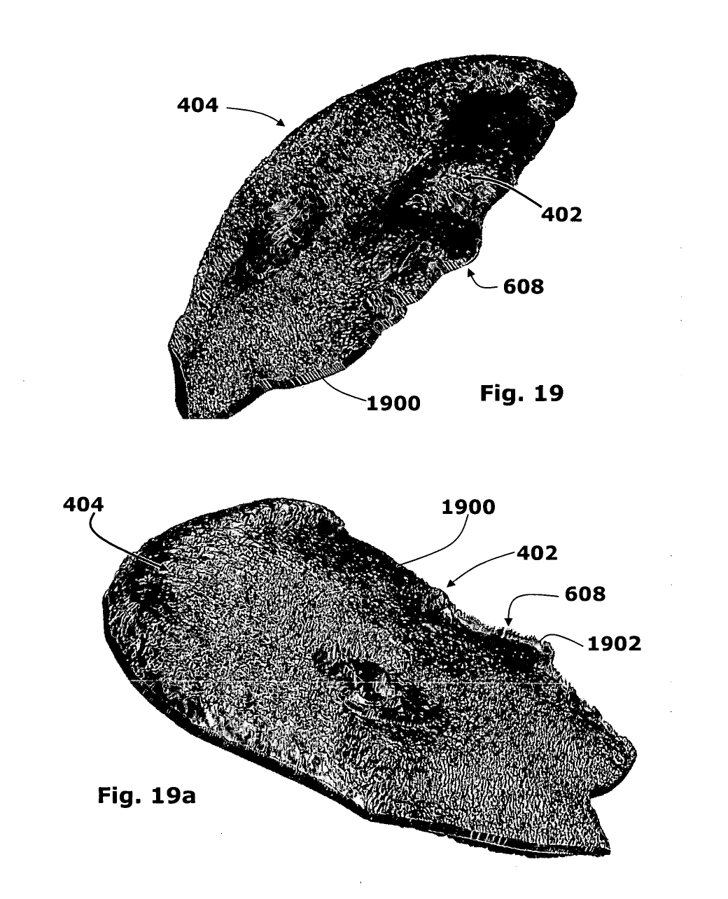

Next, the low resolution relief that was created from the image is subtracted from the template i.e. the model 1800 shown in FIG. 18 (step 230 in FIG. 2). The results of these are shown in FIGS. 19 and 19a which show the same model 1900 but rotated to different angles to show particular portions of the model. This stage raises the eyebrows and hairs back to the correct position. It will be appreciated that the hair 404 and eyebrows 402 had minimal height in the and therefore that the subtraction operation has the effect of raising these portions. However, there are still problems with the height of the some portions of the model 1900. For example the nose 608 has a negative height and in particular a vertical wall 1902 portion has been created at an edge region of the nose 608 where it steps up to zero height.

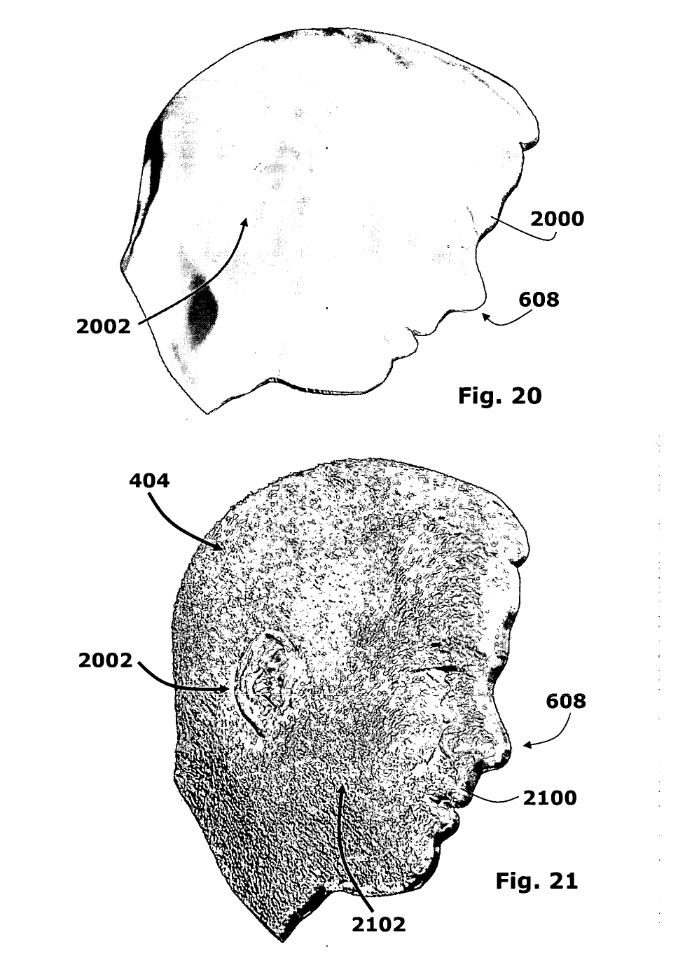

Next the image is again smoothed using the smoothing means 2613, again 100 passes of the smoothing operation (step 232 in FIG. 2). However, the skilled person will appreciate that any other number of smoothing passes may be made. For example roughly any of the following number (or any number in between these) may be suitable: 10, 20, 30, 40, 50, 60, 70, 80, 90, 110, 120, 130, 140, 150, 160, 170, 180, 190, 200. Once the smoothing has finished the relief is assigned zero height outside the area defined by the silhouette vector 500. The resulting model 2000 is shown in FIG. 20. It can again be seen that some areas (for example the nose 608 and the ears 2002) have incorrect height information.

Once the smoothing has been performed the low resolution relief that was produced from the image is now added to the model 2000 (step 234 in FIG. 2). The resulting model 2100 is shown in FIG. 21. It can be seen that the nose 608 and the ears 2002 are now positive and that the overall model 2100 provides a low relief model of the head in the image.

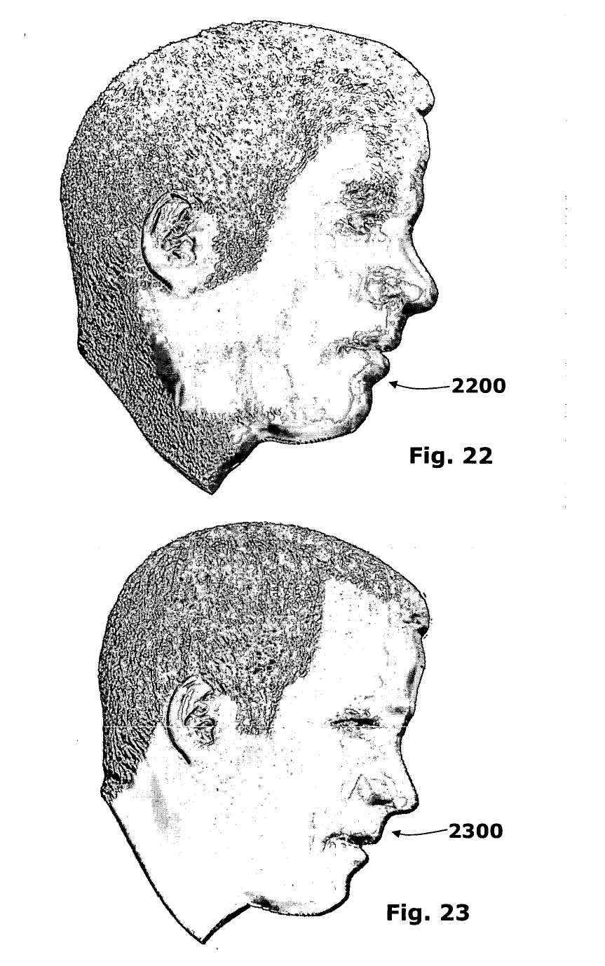

The next stage is to perform smoothing of the image, using the smoothing means 2613, to remove any undesired surface texture, for example on the cheeks 2102 and the like (step 236 in FIG. 2). It will be desirable not to over-smooth areas such as the hair and the like since details will be lost. A partially smoothed model 2200 is shown in FIG. 22 and a fully smoothed model 2300 is shown in FIG. 23.

The 3D computer model is ready to be used to produce a physical model using a Computer Numerically Controlled (CNC) milling machine (step 330). Alternatively, if a physical model from a 3D printer (i.e. a rapid prototyping machine) is required, further processing can be performed.

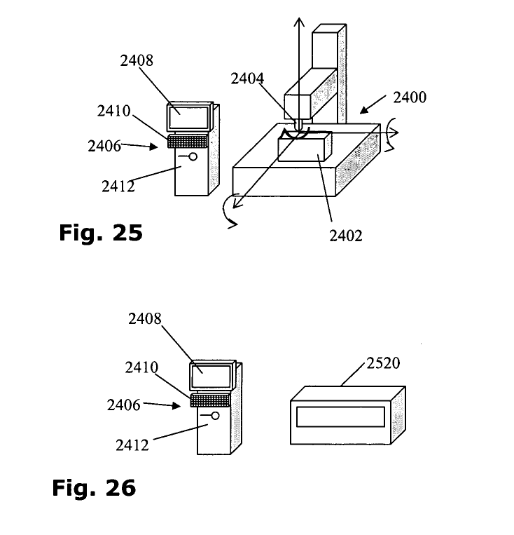

A suitable system for generating a physical model using a CNC machine is shown in FIG. 25 and comprises a CNC milling machine 2400, on which a block of material 2402 to be machined has been placed. A material removal tip 2404 removes material from the block 2402 and is controlled by the computer 2406, which comprises a display 2408, an input means (a keyboard) 2410 and a processing unit 2412. This physical model may be the result of the process, or the physical model may itself be used for additional steps (such as investment casting, or the like).

The 3D computer model held in the memory 116 of the processing circuitry 104 at this stage effectively has a variable thickness, depending upon the height of the features on the 3D computer model. Such a variable thickness is not convenient for the generation of physical representations of the 3D computer model using rapid prototyping machines. Rapid prototyping machines often rely on the deposition of material in order to build up the physical model. If the areas of the physical model are of different thickness then the cracking, warping, etc. of the physical model can occur due to differential cooling thereof. It is therefore advantageous to generate a shell, i.e. a computer model having a constant thickness using a shell generation means 2614 of the processing unit 112. In addition to preventing cracking in the physical model providing a shell is also advantageous if the physical model is to be used in an investment casting process, in which case, cracking of the cast model is also prevented and if expensive materials are used costs are reduced.

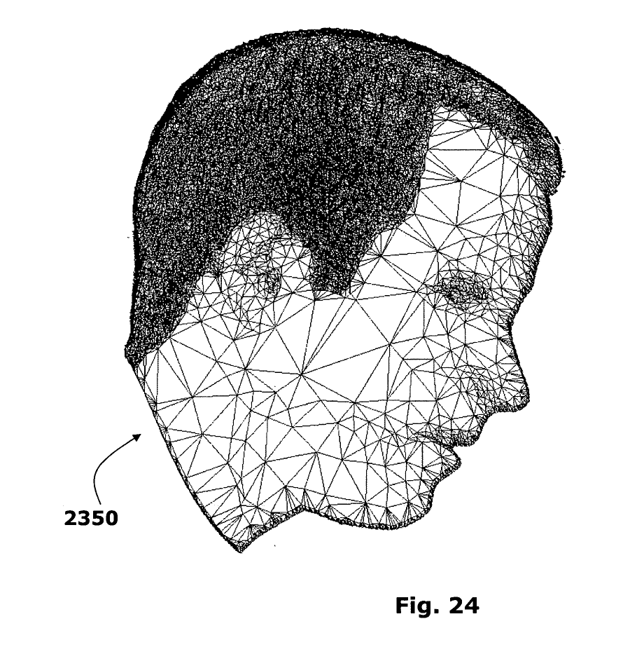

A polygon generation means 2618 of the processing unit 112 is used to produce a ‘triangulated computer model’. An example 2350 of the smooth model that has had its surface converted to polygons, in this case triangles, is shown in FIG. 24. This maps a plurality of planar triangles to cover the surface of the 3D computer model. These triangles are used by the processing circuitry of a 3D printer in a known way to produce a 3D shell computer model of the profile of a face of a specified thickness. In this embodiment a wax shell is produced by the 3D printer and such a computer model can be used in moulding processes, for example in ‘lost wax’ processes well known in the art used for casting metal physical models, or for moulding ceramics, for example forming a relief on a china plate.

A system that is suitable for the generation of rapid prototyping physical models is shown in FIG. 26 and comprises the same computer system as shown in FIG. 25 (which will not be described further) connected to a 3D printer 2520. It will be appreciated that some types of rapid prototyping machine are suitable for generating a final product (typically those that use a plastics material or a material having a metal content) although other rapid prototyping machines are only suitable for producing prototypes.

It will of course be appreciated that the process is not in anyway limited to images of faces, and that a vast number of objects could be modelled in this way. Using this process enables detailed and accurate models to be produced with greater rapidity and less artistic skill than has previously been possible with traditional methods.

1. A system arranged to model a 3D object comprising an image acquiring means arranged to receive a single 2D image of a subject and processing circuitry, the system being arranged to acquire an image from the image acquiring means, process the image using the processing circuitry and generate a 3D computer model of the object from the image.

2. A system according to claim 1 wherein the processing circuitry is used to generate a 3D model of a 3D object from a 2D image of the object.

3. A system according to claim 1 wherein the image acquiring means comprises any means of acquiring a digital 2D image, such means comprising any of the following: a digital camera; a scan of an image; a digital video recorder; a DVD player; a network connection; a machine readable medium.

4. A system according to claim 1 in which the 3D computer model comprises a low relief representation of the object.

5. A system according to claim 1 which comprises a head acquiring means arranged to isolate heads within an image acquired by the image acquiring means.

6. A system according claim 1 in which the processing circuitry comprises a surface generation means arranged to generate a surface from the image.

7. A system according to claim 6 in which the surface generation means is arranged to process the image and allocate depth information to each pixel of the image according to the tone of that pixel.

8. A system according to claim 7 in which in which the processing circuitry is arranged such that black is taken to have the lowest height, and white is taken to have the highest height.

9. A system according to claim 6 in which the processing circuitry also comprises a smoothing means arranged to smooth the surface generated by the surface generation means.

10. A system according to claim 6 in which the processing circuitry comprises a shell generation means arranged to generate a shell from the surface generated by the surface generation means.

11. A system according to claim 1 which comprises one of a rapid prototyping machine arranged to fabricate a physical representation of the 3D computer model and a CNC machine arranged to generate a physical representation of the 3D computer model.

12. A system according to claim 1 which comprises a vector creation means arranged to generate one or more vectors, which are representations of separate shapes such as lines, polylines, polygons and splines.

13. A system according to claim 1 which comprises a blending means arranged to create a blend surface from a vector onto the model of a surface.

14. A system according to claim 1 which comprises an edge detection means arranged to detect an outline of a portion of the image.

15. A method of generating a 3D computer model of an object comprising the following steps:
i. acquiring a single 2D image;
ii. using the image to obtain depth information relating to the object;
iii. applying the depth information to a template of a model and producing a 3D computer model from said depth information and said template.

16. A method according to claim 15 which generates a physical model from the computer model that has been generated.

17. A method according to claim 16 which generates the physical model using one of a rapid prototyping machine and a CNC milling machine.

18. A method according to claim 15 in which the method generates a low relief from the object.

19. A method according to claim 15 which includes the step of converting the image into a relief by taking the value of one or more of the pixels of the image into a height.

20. A method according to claim 15 which is used to generate a 3D computer model of a head.

21. A method according to claim 15 which comprises using a vector creation means to generate a silhouette vector, the silhouette vector comprising a vector around an outline of at least a portion of the image.

22. A method according to claim 21 which uses the silhouette vector to define a portion of the image from which information may be discarded.

23. A method according to claim 21 in which the vector creation means is used to create a height defining vector that is used to roughly set the height of the computer model.

24. A method according to claim 23 in which the height defining vector has a tangent that is roughly parallel to a tangent of the silhouette vector.

25. A method according to claim 23 which blends the height defining vector and the silhouette vector.

26. A method according to claim 15 which subtracts height information derived from the image from the template.

27. A method according to claim 26 which subsequently smoothes the model.

28. A method according to claim 27 which adds height information from the image to the model.

29. A method according to claim 15 which comprises generating a surface and further the step of generating a shell from the surface.

30. A machine readable medium containing instructions to cause a computer to function as the system of claim 1 when programmed thereonto.

31. A machine readable medium containing instructions to cause a computer to perform the method of claim 15 when programmed thereonto.

32. A data structure comprising a bit map image to which height information has been assigned to each pixel of said bit map.

33. A machine readable medium containing a data structure according to claim 32.

34. An object produced by the method of claim 15.

35. An object according to claim 34 which is one of the following: the representation of a head on a coin, the representations of heads on crockery, seal rings, jewellery, cameos, intaglios, a relief for the memorial industry.

36. A method of generating a 3D computer model of a 3D object from a 2D image of the object comprising the following steps:
i. acquiring a single 2D image;
ii. using the image to obtain depth information relating to the object;
iii. applying the depth information to a template of a model and producing a low relief 3D computer model from said depth information and said template.

37. A system arranged to generate a 3D computer model from a 2D image of a 3D object, the system comprising a processor arranged to process data representative of the 2D image and modify a template using height information derived from the 2D image in order to generate a 3D low relief model of the 3D object.
